(19) United States
(12) Patent Application Publication
(10) Pub. No.: US 2012/0195805 A1
(43) Pub. Date: Aug. 2, 2012

(54) FEEDER FOR DISPENSING A SOLUTION OF A SOLID MATTER DISSOLVED THEREIN

(76) Inventor: Ziv Bialik, Ramat Gan (IL)

(21) Appl. No.: 13/391,098

(22) PCT Filed: Aug. 19, 2010
(86) PCT No.: PCT/IL10/00676

§ 371 Date: Apr. 18, 2012

Related U.S. Application Data
(60) Provisional application No. 61/272,132, filed on Aug. 19, 2009.

(51) Int. Cl. B01D 11/02

(52) U.S. Cl. 422/264; 422/261

(57) ABSTRACT

The present invention provides a feeder for dispensing a solution of at least partially dissolved solid matter therein, comprising (a) at least one container; wherein said container enclosing a bulk M of solid matter; (b) at least one feeding pipe, in fluid connection with said container, adapted to introduce a stream L of flowing liquid into said container; wherein a portion P of said bulk of solid matter is at least partially dissolved within said liquid such that said solution is provided; wherein P is substantially smaller than M.

### FIELD OF THE INVENTION

The present invention relates in general to feeder for dispensing a solution of either partially or fully dissolved solid matter therein. According to one embodiment, the present invention relates to a fertilizing and irrigating systems providing for fertilizing while irrigating field crops. In more particular the present invention relates to a feeder providing for dissolving granular or powdery matter such as solid fertilizer and regulating the level of this material dispensed into the irrigation water.

### BACKGROUND OF THE INVENTION

The present invention relates in general to feeder for dispensing a solution of either partially or fully dissolved solid matter therein. According to one embodiment, the present invention relates to a fertilizing and irrigating systems providing for fertilizing while irrigating field crops.

Fertilizing by irrigation is common. Early versions of commercial systems for fertilizing by means of the irrigation water normally utilized granular fertilizers. A given quantity of the desired fertilizer, which is in the form of granular matter that is soluble in water, is first filled into a closed tank. This tank is liquid connected to the irrigating piping. Valves for regulating the pressures exerted on the solution contained in the tank versus the level of pressure existing within the irrigating piping provide for dispensing the fertilizer into the irrigation water at a rate conformal with the rate of flow of the irrigation water. The main drawback of such systems is the inherent difficulty to fine-tune the level by which the fertilizer is mixed with the irrigation water and in turn the rate of fertilizing. Especially in cases in which the utilized fertilizer dissolves relatively quickly, the total amount of fertilizer contained in the tank is rapidly drowned off the tank and gets mixed with the irrigating water within a significantly short time.

World Patent Application the publication number of which is WO06034105 discloses a system and method for fertilizing by means of the irrigating water. The disclosed system includes a closed tank for storing the granular fertilizer. A portion of the irrigating water is pressurized into the tank to dissolve the fertilizer. According to the disclosed method granules of controlled released fertilizer are utilized, such that the rate in which the fertilizer is mixed with the irrigating water is reduced to a permissible level. In U.S. Pat. No. 6,659,128 a dispenser for dispensing solutions, such as of fertilizers dissolved in water, at metered rates is disclosed. A fluid injector connected to the main fluid flow line provides for directing a portion of the fluid that is drawn from the main line into a closed tank containing the liquid fertilizer. The injected fluid provides for diluting the solution contained therein, such that the concentration of the solution that gets off the closed tank complies with a desired level. Vent proportioner ports provide for air releasing as well as setting the injection ratios and the concentration of the dispensed solution.

Advanced systems for fertilizing by irrigation utilize nowadays liquid fertilizers that are filled into tanks that are opened to the ambient atmosphere. Predefined doses of the dissolved fertilizer at a given concentration are repeatedly dispensed off this tank by means of a dedicated pump that further injects them into the irrigating piping system. However a prior effort for dissolving the fertilizers is required, which in turn increases the costs involved. Furthermore the logistic associated with transporting and storing liquids is more expensive and complex compared to the logistic involved with granular fertilizers. Therefore feeders of liquid fertilizer utilizing granular and/or powdery solid matter; that avoid the usage of pressure rated components; and are therefore less expensive to manufacture and maintain; that provide for repeatedly dispensing given doses of dissolved fertilizer at controlled concentration levels, are beneficial and are still a long felt need.

### SUMMARY OF THE INVENTION

It is one object of the present invention to provide a feeder for dispensing a solution of either partially or fully dissolved solid matter therein, comprising
a. at least one container; wherein said container enclosing a bulk M of solid matter;
b. at least one feeding pipe, in fluid connection with said container, adapted to introduce an amount or volume L of a stream of flowing liquid into said container wherein a portion P of said bulk of solid matter is either partially or fully dissolved within said liquid such that said solution is provided; wherein P is substantially smaller than M, such that said container constantly contains a positive portion of said solid matter; said positive portion is defined by the subtraction between M and P.

It is another object of the present invention to provide the feeder as defined above, additionally comprising means for repeatedly measuring the level of at least one characteristic associated with said solution resident in said container and deriving the level of concentration of said matter in said solution resident in said container.

It is another object of the present invention to provide the feeder as defined above, wherein said stream of flowing liquid is introduced in either a continuous or a batch-like manner.

It is another object of the present invention to provide the feeder as defined above, wherein said amount or volume L of liquid is smaller than M.

It is another object of the present invention to provide the feeder as defined above, wherein said amount or volume L of liquid is greater than M.

It is another object of the present invention to provide the feeder as defined above, wherein said feeder additionally comprising at least one sensing means adapted to indicate at least one characteristic of said solution.

It is another object of the present invention to provide the feeder as defined above, wherein said sensing means are selected from a group consisting of mass flow meter, electrical conductive sensor, level indicator such as a float, a temperature sensor or any combination thereof.

It is another object of the present invention to provide the feeder as defined above, wherein said characteristic is selected from a group consisting of a temperature of said solution, the hydrostatic pressure, the mass or density of a portion of said solution evacuated off said container, the density, the electrical conductivity of said solution, and any combination thereof.

It is another object of the present invention to provide the feeder as defined above, wherein said feeder additionally comprising at least one outlet pipe adapted for extracting at least a portion of said solution.

It is another object of the present invention to provide the feeder as defined above, wherein said solid matter is in the form selected from a group consisting of powder, granular form or any combination thereof.

It is another object of the present invention to provide the feeder as defined above, wherein said liquid is selected from a group consisting of hydrophobic, hydrophilic solvents, lipophilic solvents, Lipophobic solvents, organic solvents, inorganic solvents or any combination thereof.

It is another object of the present invention to provide the feeder as defined above, wherein said liquid is water.

It is another object of the present invention to provide the feeder as defined above, wherein said solid bulk M of solid matter is maintained wet or slurry.

It is another object of the present invention to provide the feeder as defined above, wherein M is in the range of micro-grams to several hundreds of tons.

It is another object of the present invention to provide the feeder as defined above, wherein P is in the range of micro-grams to several hundreds of tons.

It is another object of the present invention to provide the feeder as defined above, additionally comprising means adapted to introduce at least one solvent; said at least one solvent is adapted to flush excessive quantities of solute.

It is another object of the present invention to provide the feeder as defined above, wherein said stream of flowing liquid is synchronized with portion of said solution extracted out of said container.

It is another object of the present invention to provide the feeder as defined above, additionally comprising sensing means adapted to indicate and maintain the amount of said solution in said container above a predefined threshold.

It is another object of the present invention to provide, the feeder as defined above, wherein said predefined threshold is at least a few millilitres.

It is another object of the present invention to provide the feeder as defined above, wherein container is in fluid connection with the ambient atmosphere.

It is another object of the present invention to provide the feeder as defined above, wherein at least a portion of the wall of said outlet pipe is perforated.

It is another object of the present invention to provide the feeder as defined above, additionally comprising a filter adapted to prevent granules or solid matter from entering said outlet pipe.

It is another object of the present invention to provide the feeder as defined above, additionally comprising at least one skirting flange adapted to prevent leaking of said liquid out of said container.

It is another object of the present invention to provide the feeder as defined above, wherein said container is made of material selected from a group consisting of plastic resin, polypropylene, a metal, stainless steel or any combination thereof.

It is another object of the present invention to provide the feeder as defined above, wherein said material is adapted to prevent corrosion within said container.

It is another object of the present invention to provide the feeder as defined above, additionally comprising at least one controller adapted to verify the correct dosing of said stream of liquid introduced into said container.

It is another object of the present invention to provide the feeder as defined above, additionally comprising at least one level indicator adapted to maintain the amount of liquid within said container at a predefined level.

It is another object of the present invention to provide the feeder as defined above, wherein said level indicator is a float.

It is another object of the present invention to provide the feeder as defined above, wherein said feeder comprising a combination of at least two containers, each of which comprises a substantially different solid matter or a mixture of different solid matters.

It is another object of the present invention to provide the feeder as defined above, wherein said solid matter is selected from a group consisting of fertilizers, pesticides, chemicals, minerals, salts, or any combination thereof; further wherein said feeder is used in at least one selected from process industry, chemistry industry, pesticides industry, disinfestations, food industry (e.g., beverage industry), textile, cosmetics, detergents productions, pharmaceutical industry, or any combination thereof.

It is another object of the present invention to provide the feeder as defined above, further comprising an intermediate collecting container, in fluid connection with the ambient atmosphere for intermediately storing said extracted portions of said solution.

It is another object of the present invention to provide the feeder as defined above, wherein said outlet pipe is structured as a siphon.

It is another object of the present invention to provide the feeder as defined above, wherein said feeder is adapted to be used in a fertilizing and irrigating system.

It is another object of the present invention to provide a feeder for fertilizing and irrigating system having a receiving tank structured and arranged for receiving and storing a bulk of solid fertilizer, said feeder comprising:
at least one receiving tank; wherein said receiving tank receives, stores and contains a bulk of solid fertilizer of a given quantity
a feeding pipe connectable to a line leading fresh water for feeding said tank with discrete portions of said fresh water, such that a solution of said fertilizer is obtained within said receiving tank;
an outlet pipe for extracting discrete portions of said solution out of said receiving tank, and,
at least one measuring mean for sensing at least one characteristic associated with said portion of solution;
wherein said at least one characteristic is selected from the group consisting of the temperature of said solution; the level of hydrostatic pressure measured close to the aperture of said outlet pipe for a given height of the top level of solution resident in said receiving tank above the bottom of said receiving tank; the mass of a portion of solution evacuated off said receiving tank; the density of an evacuated portion of solution off said receiving tank; the electrical conductivity of the irrigating water after getting mixed with said evacuated portion of solution, and any combination thereof.

It is another object of the present invention to provide the feeder as defined above, wherein said receiving tank is fluid connected to the ambient atmosphere.

It is another object of the present invention to provide the feeder as defined above, further comprising an intermediate collecting container, which is fluid connected to the ambient atmosphere for intermediately storing said evacuated portions of solution.

It is another object of the present invention to provide the feeder as defined above, wherein said outlet pipe structured and arranged as a siphon.

It is another object of the present invention to provide the feeder as defined above, further comprising a measuring pipe, an air pump and a pressure sensor, and wherein one end of said measuring pipe closely disposed above the bottom, of said receiving tank and the, other end of said measuring pipe upwardly extends above the top of said receiving tank.

It is another object of the present invention to provide the feeder as defined above, wherein said fresh water is introduced in either a continuous or a batch-like manner.

It is another object of the present invention to provide the feeder as defined above, wherein said solid fertilizer is in the form selected from a group consisting of powder, granular form or any combination thereof.

It is another object of the present invention to provide the feeder as defined above, wherein said solid fertilizer is maintained wet or slurry.

It is another object of the present invention to provide the feeder as defined above, additionally comprising means adapted to introduce at least one solvent; said at least one solvent is adapted to flush excessive quantities of solute.

It is another object of the present invention to provide the feeder as defined above, wherein said introduction of said fresh water is synchronized with portion of said solution extracted out of said receiving tank.

It is another object of the present invention to provide the feeder as defined above, additionally comprising sensing means adapted to indicate and maintain the amount of said solution in said receiving tank above a predefined threshold.

It is another object of the present invention to provide the feeder as defined above, wherein said predefined threshold is at least a few millilitres.

It is another object of the present invention to provide the feeder as defined above, wherein at least a portion of the wall of said outlet pipe is perforated.

It is another object of the present invention to provide the feeder as defined above, additionally comprising a filter adapted to prevent granules or solid matter from entering said outlet pipe.

It is another object of the present invention to provide the feeder as defined above, additionally comprising at least one skirting flange adapted to prevent leaking of said liquid out of said receiving tank.

It is another object of the present invention to provide the feeder as defined above, wherein said receiving tank is made of material selected from a group consisting of plastic resin, polypropylene, a metal, stainless steel or any combination thereof

It is another object of the present invention to provide the feeder as defined above, wherein said material is adapted to prevent corrosion within said receiving tank.

It is another object of the present invention to provide the feeder as defined above, additionally comprising at least one controller adapted to verify the correct dosing of said stream of liquid introduced into said receiving tank.

It is another object of the present invention to provide the feeder as defined above, additionally comprising at least one level indicator adapted to maintain the amount of liquid within said receiving tank at a predefined level.

It is another object of the present invention to provide the feeder as defined above, wherein said level indicator is a float.

It is another object of the present invention to provide the feeder as defined above, wherein said feeder comprising a combination of at least two receiving tank, each of which comprises a substantially different solid matter or a mixture of different solid fertilizer.

It is another object of the present invention to provide a method for dispensing a solution of either partially or fully dissolved solid matter therein. The method comprises steps selected inter alia from:
a. obtaining:
   i) at least one container; wherein said container accommodates a bulk M of solid matter; and,
   ii) at least one feeding pipe;
b. accommodating within said container said bulk M of solid matter;
c. fluidly connecting at least one of said feeding pipes with at least one of said containers;
d. introducing an amount or volume L of a stream of flowing liquid into said container, thereby gradually dissolving a portion P of said bulk of solid matter within said liquids and providing said solution; where P is substantially smaller than M, such that said container constantly contains a positive portion of said solid matter; said positive portion is defined by the subtraction between M and P.

It is another object of the present invention to provide the method as defined above, wherein said step of introducing a stream of flowing liquid is performed in either a continuous or a batch-like manner.

It is another object of the present invention to provide the method as defined above, wherein said amount or volume L of liquid is smaller than M

It is another object of the present invention to provide the method as defined above, wherein said amount or volume L of liquid is greater than M.

It is another object of the present invention to provide the method as defined above, additionally comprising step of repeatedly measuring the level of at least one characteristic associated with said solution resident in said container.

It is another object of the present invention to provide the method as defined above, additionally comprising step of deriving the level of concentration of said matter in said solution resident in said container.

It is another object of the present invention to provide the method as defined above, additionally comprising steps of (a) providing said feeder with at least one sensing means; and (b) indicating at least one characteristic of said solution.

It is another object of the present invention to provide the method as defined above, additionally comprising step of selecting said sensing means from a group consisting of mass flow meter, electrical conductive sensor, level indicator such as a float, a temperature sensor or any combination thereof.

It is another object of the present invention to provide the method as defined above, additionally comprising step of selecting said characteristic from a group consisting of a temperature of said solution, the hydrostatic pressure, the mass or density of a portion of said solution evacuated off said container, the density, the electrical conductivity of said solution, and any combination thereof.

It is another object of the present invention to provide the method as defined above, additionally comprising step of providing said feeder with at least one outlet pipe adapted for extracting at least a portion of said solution.

It is another object of the present invention to provide the method as defined above, additionally comprising step of providing said solid matter in the form selected from a group consisting of powder, granular form or any combination thereof.

It is another object of the present invention to provide the method as defined above, additionally comprising step of selecting said liquid from a group consisting of hydrophobic, hydrophilic solvents, lipophilic solvents, Lipophobic solvents, organic solvents, inorganic solvents or any combination thereof.

It is another object of the present invention to provide the method as defined above, additionally comprising step of selecting said liquid from water.

It is another object of the present invention to provide the method as defined above, wherein said solid bulk M of solid matter is maintained wet or slurry.

It is another object of the present invention to provide the method as defined above, wherein M is in the range of micro-grams to several hundreds of tons.

It is another object of the present invention to provide the method as defined above, wherein P is in the range of micro-grams to several hundreds of tons.

It is another object of the present invention to provide the method as defined above, additionally comprising step of introducing at least one solvent; said at least one solvent is adapted to flush excessive quantities of solute.

It is another object of the present invention to provide the method as defined above, additionally comprising step of synchronizing said stream of flowing liquid with portion of said solution extracted out of said container.

It is another object of the present invention to provide the method as defined above, additionally comprising step of indicating and maintaining the amount of said solution in said container above a predefined threshold.

It is another object of the present invention to provide the method as defined above, wherein said predefined threshold is at least a few millilitres.

It is another object of the present invention to provide the method as defined above, additionally comprising step of fluidly connecting said container with the ambient atmosphere.

It is another object of the present invention to provide the method as defined above, additionally comprising step of providing at least a portion of the wall of said outlet pipe perforated.

It is another object of the present invention to provide the method as defined above, additionally comprising step of preventing granules or solid matter from entering said outlet pipe by providing said feeder with a filter.

It is another object of the present invention to provide the method as defined above, additionally comprising step of providing said feeder with at least one skirting flange for preventing leaking of said liquid out of said container.

It is another object of the present invention to provide the method as defined above, additionally comprising step of providing said container from a material selected from a group consisting of plastic resin, polypropylene, a metal, stainless steel or any combination thereof.

It is another object of the present invention to provide the method as defined above, additionally comprising step of preventing corrosion within said container.

It is another object of the present invention to provide the method as defined above, additionally comprising step of providing said feeder with at least one controller adapted to verify the correct dosing of said stream of liquid introduced into said container.

It is another object of the present invention to provide the method as defined above, additionally comprising step of providing said feeder with at least one level indicator adapted to maintain the amount of liquid within said container at a predefined level.

It is another object of the present invention to provide the method as defined above, additionally comprising step of selecting said level indicator from a float.

It is another object of the present invention to provide the method as defined above, additionally comprising step of providing said feeder with a combination of at least two containers, each of which comprises a substantially different solid matter or a mixture of different solid matters.

It is another object of the present invention to provide the method as defined above, additionally comprising step of selecting said solid matter from a group consisting of fertilizers, pesticides, chemicals, minerals, salts, or any combination thereof; further wherein said feeder is used in at least one selected from process industry, chemistry industry, pesticides industry, disinfestations, food industry (e.g., beverage industry), textile, cosmetics, detergents productions, pharmaceutical industry, or any combination thereof.

It is another object of the present invention to provide the method as defined above, additionally comprising step of providing said feeder with an intermediate collecting container, in fluid connection with the ambient atmosphere for intermediately storing said extracted portions of said solution.

It is another object of the present invention to provide the method as defined above, additionally comprising step of providing said outlet pipe is structured as a siphon.

It is another object of the present invention to provide the method as defined above, wherein said feeder is adapted to be used in a fertilizing and irrigating system.

It is another object of the present invention to provide the method as defined above, further comprising step of spaying discrete portions of said liquid on top of said solid matter for dissolving respective portions of said solid matter, and wherein said discrete portions of said liquid are significantly small.

It is another object of the present invention to provide the method as defined above, additionally comprising step of extracting said solution by means selected from a pump, gravitation or any combination thereof.

It is another object of the present invention to provide the method as defined above, additionally comprising step of measuring of hydrostatic pressure by measuring the level of pressure of air compressed into a measuring pipe one end of which dipped in said solution, and wherein said measuring effected at a stage in which the level of said solution contained in said pipe is given.

It is another object of the present invention to provide the method as defined above, additionally comprising step of introducing into said container an additionally amount of said solid matter.

It is another object of the present invention to provide the method as defined above, additionally comprising step of repeating said step of introducing into said container an additionally amount of said solid matter.

It is another object of the present invention to provide a method for dispensing aqueous solution of a solid fertilizer. The method comprises inter alia steps of:
a. providing at least one receiving tank; wherein said receiving tank contains bulk of solid fertilizer of a given quantity;
b. gradually dissolving said solid fertilizer in said receiving tank by repeatedly feeding said receiving tank with discrete portions of fresh water;
c. repeatedly measuring the level of at least one characteristic associated with said solution resident in said receiving tank and deriving the level of concentration of said fertilizer in said solution resident in said receiving tank by employing said measured level, and
d. repeatedly evacuating portions of given quantities and concentration off said receiving tank, and
wherein said feeder comprises an outlet pipe and a feeding pipe, and wherein said evacuating accomplished by means of said outlet pipe an aperture of which closely disposed above the bottom of said receiving tank, and wherein said feeding accomplished by means of said feeding pipe which is structured and arranged to lead fresh water into said receiving tank, such that the level of said aqueous solution resident in said receiving tank does not get below a predefined threshold level, and wherein said at least one characteristic selected from a group of characteristics consisting of a temperature of said solution, the level of hydrostatic pressure measured close to the aperture of said outlet pipe for a given height of the top level of solution resident in the receiving tank above to bottom of said receiving tank, the mass of a portion of solution evacuated off said receiving tank, the density of a portion of solution evacuated off said receiving tank, the electrical conductivity of the irrigating water after getting mixed with said evacuated portion of solution, and any combination thereof.

It is another object of the present invention to provide the method as defined above, further comprising spaying said discrete portions of fresh water on top of said solid fertilizer for dissolving respective portions of said solid fertilizer, and wherein said discrete portions of fresh water are significantly small compared to said given quantity.

It is another object of the present invention to provide the method as defined above, further comprising intermediately storing said evacuated portions of solution in an intermediate collecting container.

It is another object of the present invention to provide the method as defined above, wherein said evacuating accomplished by means of a pump, or gravitation or any combination thereof.

It is still another object of the present invention to provide the method as defined above, wherein said measuring of said hydrostatic pressure accomplished by measuring the level of pressure of air compressed into a measuring pipe one end of which dipped in said aqueous solution, and wherein said measuring effected at a stage in which the level of said aqueous solution contained in said pipe is given.

It is lastly an object of the present invention to provide the method as defined above, wherein said level of aqueous solution contained in said pipe equals said predefined threshold.

### BRIEF DESCRIPTION OF THE DRAWINGS

FIG. 1 is a scheme of a feeder of a fertilizer irrigating system of the present invention;

FIG. 2 is a scheme of a feeder of a fertilizer irrigating system according to a preferred embodiment of the present invention.

### DETAILED DESCRIPTION OF THE PRESENT INVENTION

The following description is provided, alongside all chapters of the present invention, so as to enable any person skilled in the art to make use of the invention and sets forth the best modes contemplated by the inventor of carrying out this invention. Various modifications, however, is adapted to remain apparent to those skilled in the art, since the generic principles of the present invention have been defined specifically to provides a liquids' feeder that utilizes bulk of solid raw material (powdery and/or granular).

The present invention provides a feeder for dispensing a solution of either partially or fully dissolved solid matter therein. The feeder comprises (a) at least one container; wherein said container enclosing a bulk M of solid matter; and, (b) at least one feeding pipe, in fluid connection with said container, adapted to introduce an amount or volume L of a stream of flowing liquid into said container; wherein a portion P of said bulk of solid matter is either at least partially or fully dissolved within said liquid such that said solution is provided; wherein P is substantially smaller than M, such that said container constantly contains a positive portion of said solid matter; said positive portion is defined by the subtraction between M and P.

The term “amount” refers hereinafter to a quantitative property namely a physical quantitative e.g., volume, mass, weight, the absolute volume, absolute mass or absolute volume (e.g., the absolute volume of a powder is the volume of said powder when the same is compresed, i.e., without the air).

According to one embodiment of the present invention, the feeder is used for liquid fertilizers. However, it should be emphasized that one or more feeders of the present invention can be utilized in any application in which a solution of a desired concentration, or a mixture of various partial concentrations, is to be prepared.

The device and method of the present invention can be utilized in e.g., the process industry, chemistry industry, pesticides industry, disinfestations, food industry (e.g., beverage industry namely, beer), textile, detergents productions, pharmaceutical industry, cosmetics, et cetera.

Furthermore, it should be emphasized that the solid matter used in the present invention can be any selected from fertilizers, pesticides, chemicals, minerals, salts, or any combination thereof

The feeder according to one embodiment of the present invention comprises a receiving tank for receiving a solid matter (e.g., fertilizer) that is soluble in water.

The quantity of the solid matter stored in the tank need not be accurately measured, according to the present invention.

The receiving tank is intermittently fed with portions of fresh water for gradually dissolving respective portions of the solid matter contained therein. In accordance with the present invention most of the solid matter contained in the receiving tank most of the time along which a fertilizing session is accomplished, is wet and/or slurry.

The quantities of solid matter (e.g., fertilizer) dissolved in the aqueous solutions that are repeatedly generated and contained in the tank are very small compared to the residual quantity of wet and/or dry solid matter contained therein most of the time.

By introducing small portions of solvent that are adapted to flush excessive quantities of solute (that are saturated or at least of a relatively high concentration) discrete portions of saturated solution are obtained.

Said discrete portions of saturated solution and/or solutions of a relatively high concentration, are intermittently taken out of the tank and further injected into the main pipe leading the water towards the targeted field.

It should be noted that the quantities of said discrete portions of saturated solution and/or solutions of a relatively high concentration comply with the currently measured rate of flow of the irrigation water.

Feeding the tank with portions of fresh water is synchronized with the quantities of solution evacuated off the tank, such that the level of saturated solution and/or highly concentrated solution that is resident in the tank does not get below a predefined threshold.

Therefore, a quantity of saturated or highly concentrated solution occupies an internal space of the receiving tank that is dispose above its bottom. The inlet aperture of the outlet pipe that evacuates the dissolved solid matter (e.g., fertilizer) to be further mixed with the irrigating water is dipped in this solution along the entire session (e.g., fertilizing session).

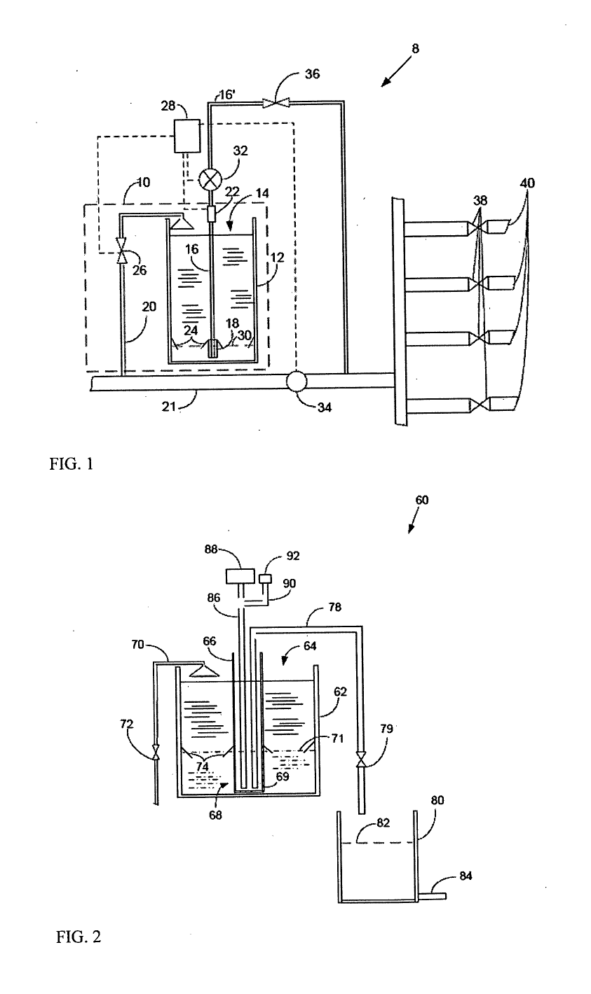

Reference is first made to FIG. 1 in which a scheme of a fertilizing and irrigating system 8 including feeder 10 according to one embodiment of the present invention is shown.

Feeder 10 includes receiving tank 12 for receiving and containing granular and/or powdery fertilizer 14, which is fluidly connected to the ambient atmosphere. Outlet pipe 16, is connected to a pump that draws dissolved fertilizer out of tank 12.

The wall of the lower segment of outlet pipe 16 is perforated and is lined with filter 18. The cutoff limit of filter 18 is adapted to avoid granules or any solid matter from getting into outlet pipe 16.

Feeding pipe 20, which is connected to main pipe 21, intermittently leads fresh water into tank 12.

According to another embodiment of the present invention different means for measuring characteristics of at least a portion of the solution are provided. Such means can be selected from a group consisting of mass flow meter 22, electrical conductive sensor, level indicator such as a float, a temperature sensor or any combination thereof.

As described above, said means can be a mass flow meter 22. Said mass flow meter 22 is adapted to measure the mass of said solution's portions evacuated off tank 12.

Said measurement of the mass or density of the solution enables, according to the present invention, the derivative of the instantaneous concentration of the dissolved fertilizer at any given moment (i.e., real time measurement).

Additionally or alternatively said means for measuring a characteristic of the generated solutions can be e.g., an electrical conductive sensor which measures the electrical conduciveness of the dissolved fertilizer after the same is being diluted by said mix with said irrigating water.

The measured levels of electrical conductivity enable one to derive the concentration of the aqueous solutions of the e.g., fertilizer that are repeatedly evacuated off the feeder.

Optional circumferential skirting flanges 24 avoid leaking of water along the sidewall of tank 12 and/or the wall of filter 18 thereby assuring that the granular fertilizer gets wetted by the incoming fresh water and transforming it into slurry matter.

Tank 12 is typically made of plastic resin, such as polypropylene, or a metal, such as stainless steel, that sustain the harsh environmental conditions in the field and are chemically passive to the chemical composition of the fertilizer utilized, to avoid its corrosion.

Exemplary capacity levels of tank 12 are within the range of 100-500 Kg of solid matter (e.g., granular fertilizer).

Two stage, or continuously varying valve 26 that is electrically controlled by system controller 28 is adapted to enable the correct dosing of the fresh water portions introduced in feeding cycle of the feeder.

According to another embodiment of the present invention, a level indicator such as a float, not shown, is provided. Said level indicator is electrically connected to system controller 28 and is adapted to retain the level of water (indicated by the dashed line 30) at a desired level that does not decrease below the predefined threshold level of minimal quantity of solution that has to be present within tank 12, according to the present invention.

Another exemplary means for measuring a feature/characteristic of the solution from which the concentration of the solution can be derived is a temperature sensor. Such sensor is preferably housed within outlet pipe 16 and is electrically connected to the system controller 28.

The level of temperature of a saturated solution can, again, enable the derivation of the concentration of the dissolved solid matter (e.g., fertilizer), as known. Practically, the temperature sensor and/or mass flow meter 22 are mounted on segment 16′ of the outlet pipe that leads the dissolved matter (e.g., fertilizer) towards the main piping of the system (e.g., irrigation system).

Pump 32 is intermittently activated by controller 28 along time intervals which are compliant with the calculated, measured and/or derived concentration of the dissolved matter (e.g., fertilizer) and the rate of flow of water through main pipe 21.

This rate of flow is measured by means of mass or volumetric flow meter 34 that is electrically connected to controller 28 (The dashed lines connecting members 22, 26, 32 and 34 with controller 28 indicate the electrical wiring that provide for electrically connecting them to the controller).

Unidirectional valve 36 avoids the water from main pipe 21 from getting backwards into pump 32. Faucets 38 such any of known in the art faucets provide the connection of the respective pipe of pipes 40 to direct the irrigation carrying the e.g., fertilizer towards the targeted fields.

Reference is now made to FIG. 2 in which a segment of a scheme of feeder for fertilizing and irrigating system 60, in accordance with a preferred embodiment of the present invention, is shown.

Tank 62 that is fluidly connected to the ambient atmosphere provides storage of the solid fertilizer 64 (granular and/or powdery).

Cylinder 66 has a bottom and lower segment 68 that are perforated and lined with filter 69. The cutoff limit of this filter avoids any solid matter, tiny granules, particles and/or grains of powder to get into the lumen of cylinder 66.

Feeding pipe 70 provides for intermittently spraying fresh water into tank 62. Feeding tank 62 is fed with fresh water whenever the level 71 of water resident in tank 62 gets below a predefined threshold level.

Sensing level 71 is accomplished by means of a level indicator, such as electric electrodes, or a float, that is electrically connected to the system controller, not shown.

The quantities of water intermittently fed into tank 62 need not be accurately dosed as long as each fed portion is of a size exceeding a predefined minimal quantity that can generate a significant quantity of solution to be further evacuated off the tank prior to the next feeding cycle.

Skirting flanges 74 avoid leakage of incoming water along the walls of tank 62 or cylinder 66. Siphon 78, which is a pipe shaped as the alphabetical letter “U” is adapted to evacuate liquids off the lumen of cylinder 66 by gravitation.

Dosing the evacuated portion of solution as well as activating evacuation is accomplished by means of valve 79. Optionally additional upper threshold level is similarly implemented such as by means of additional float that is disposed at a predefined height above the aforementioned level indicator. Feeding the receiving tank with water is activated when the level of solution that is present in the receiving tank gets down to the threshold level.

Feeding the tank with water continues as long as the elapsed time is either smaller than a predefined time interval, or up to the point in which the level of solution present in the tank reaches the upper threshold.

In such cases a solution's portion is evacuated out of the tank along a time interval during which the level of solution within the tank decreases to the threshold level. Therefore, a given quantity of the solution is taken out of the tank either by measuring the time along which evacuating is effected, or by taking out the respective volume (which is known) of solution that occupies the space of the tank in between the upper and lower threshold levels.

The evacuated portion of the dissolved fertilizer (i.e., the solution) gets into intermediate collecting tank 80. Intermediate collecting tank 80 can accumulate portions of solution that are taken out of one or a number of different feeders, each of which similarly dissolves gradual matter (i.e., fertilizer) to get portions of solutions of respective concentrations.

Intermediate collecting tank 80, which is fluidly connected to the ambient atmosphere, is disposed below the bottom of tank 62. Outlet pipe 84 is adapted to deliver fluids contained within tank 80 towards the pump that further derives them into the irrigating piping.

The aperture as well as a lower segment of measuring pipe 86 is dipped into the solution that residents within cylinder 66 and in tank 62. Relatively small air pump 88 moderately compresses air into measuring pipe 86. Access of air gets out through miniature aperture located at the wall of pipe 90, which branches off measuring pipe 86. Pressure sensor 92 that seals off the open end of pipe 90 provides for measuring the pressure of the air within pipe 90. The level of air pressure within pipe 90 equals the instantaneous level of the hydrostatic pressure measured at the aperture of measuring pipe 86.

Measuring the air pressure is accomplished according to the present invention at the moment in which the level of fluid in tank 62 reaches the aforementioned predefined threshold level. The hydrostatic pressure to be measured equals, up to a scaling factor, to the height of the level of solution multiplied by its density (i.e., the pressure, p, exerted by a column of liquid of height h and density ρ, and g is the acceleration due to gravity) is indicated by the following formula:

p=ρgh

The height of the liquid contained within the tank is known at any given moment. Therefore the density of the solution resides at the bottom of the tank as well as the concentration of the dissolved fertilizer can be derived by using the respective measured level of air pressure.

In turn, given quantities of the solution, as well as the partial concentrations of each of the solutes, can be further pumped off intermediate collecting tank 80 and pressurized into the irrigating piping, such that the fertilizing is accomplished at a desired rate.

For operating the feeder described with reference to FIG. 2 hereinabove, first its receiving tank has to be loaded with a given quantity of solid fertilizer, or with predefined quantities of different kinds of fertilizers that are properly selected in accordance with their partial concentrations within a saturated aqueous solution.

Then a first quantity of fresh water is introduced into the receiving tank. This quantity of water is either calculated in consideration with the above mentioned threshold level, or is experimentally measured.

This quantity of water generates a portion of solution that is not smaller in size compared to a given level.

From this moment on, cycles in which alternately a discrete portion of solution is evacuated off the receiving tank and a discrete portion of fresh water is introduced back into the receiving tank; wherein the level of the air pressure within the measuring pipe is measured prior to each introduction of fresh water, go repeatedly on.

These cycles continue on as long as the residual quantity of solid matter that is present in the receiving tank exceeds a minimal level such that it can generate saturated solution with the next incoming potion of fresh water.

Granular and/or powdery fertilizer can be added to the receiving tank of a feeder at any time as desired, even while the system is operating. The quantities of fresh water that are intermittently introduced into the receiving tank are such selected that at least a predefined minimal quantity of newly generated aqueous solution of the solid fertilizer can be further evacuated and yet a minimal quantity of solution is retained therein.

The gradual dissolution of the solid fertilizer is such accomplished that the quantity of the wet and/or dry solid fertilizer that is present in the receiving tank along most of the fertilizing session significantly exceeds the quantity of dissolved fertilizer that is present in the aqueous solution resident in the receiving tank.

The quantities of fresh water repeatedly introduced into the tank need not be of the same level. For example, at the initial stages, when the level of fertilizer stored in the tank is relatively high, the quantities of fresh water are larger, when compared to the quantities of fresh water introduced at stages in which the level of the solid fertilizer is relatively lower.

Nevertheless, the solution contained within the tank is saturated or at least of a relatively high concentration almost along the entire fertilizing session. Fertilizers dissolved in water are intermittently injected into the piping of the irrigating system in pulses, as is widely known, in compliance with the rate of flow of the fresh water such as measured at a point along the line leading irrigating water.

A new portion of fresh water is introduced into the tank whenever the level of solution contained in the tank is lowered and reaches a computed or measured threshold level complying with the aforementioned minimal quantity of solution.

According to another embodiment, a combination of one or more receiving tanks can be employed according to the present invention when a mixture of different fertilizers is to be injected into the irrigation water. In such cases each of the tanks of the different feeders is employed to store a granular fertilizer of one kind, or a mixture of different fertilizers, their respective partial concentrations in the saturated solution are of levels that are close to each other.

In such cases an optional intermediate collecting tank stores portions of liquid fertilizers that are taken out of the various feeders.

In such an embodiment, the system which includes two or more receiving tanks, each of which is furnished with its own mean for measuring a characteristic of the respective aqueous solution, will each be connected to a single controller or to its own self operated controller.

Each of the receiving tanks is also connected to a dedicated pump for intermittently pumping the saturated solution out.

Additional pump/s for withdrawing out the accumulated solution from the intermediate collecting tank and further for injecting the same into the main piping of the irrigation system can be provided.

Obviously the last pump that injects the mixed solutions of the different fertilizers into the main piping is synchronized with the pumps of the various receiving tanks. Optionally, two or more different feeders are controlled by a common controller.

One or more feeders of the invention can be further employed in any application in which a solution of a desired concentration, or a mixture of various partial concentrations, is to be prepared. Namely, such feeders can be incorporated into systems as described hereinabove. Except that the fertilizers are substituted with the soluble compositions considered, and the water is substituted with the respective solvent.

An access of the soluble matter is filled into the receiving tank of each of the feeders, quantities of solvent are intermittently introduced into the respective receiving tank whenever the quantity of saturated solution contained therein gets below the respective minimal threshold, such that the quantity of saturated solution exceeds the respective minimal quantity.

Portions of saturated solution are intermittently taken out of the respective receiving tank by means of its dedicated pump and further injected into the main pipe carrying the solvent.

The controller is operative in retaining the magnitudes of the portions of saturated solution that are taken out of the respective tank and the rate by which such evacuating is accomplished in compliance with the rate of flow of the pure solvent through the main pipe. Thereby, the desired concentration of the various composition delivered in the main line is achieved.

Such operation is feasible whenever the desired concentration is lower compared to the concentration of the respective saturated solutions at the same temperature.

Hence, it is within the scope of the present invention to provide a feeder for dispensing a solution of either at least partially or fully dissolved solid matter therein, comprising
a. at least one container; wherein said container enclosing a bulk M of solid matter;
b. at least one feeding pipe, in fluid connection with said container, adapted to introduce an amount or volume L of a stream of flowing liquid into said container wherein a portion P of said bulk of solid matter is either at least partially or fully dissolved within said liquid such that said solution is provided; wherein P is substantially smaller than M, such that said container constantly contains a positive portion of said solid matter; said positive portion is defined by the subtraction between M and P.

According to another embodiment of the present invention, the feeder additionally comprising means for repeatedly measuring the level of at least one characteristic associated with said solution resident in said container and deriving the level of concentration of said matter in said solution resident in said container.

According to another embodiment of the present invention, the stream of flowing liquid is introduced in either a continuous or a batch-like manner.

According to some embodiments, a thin layer of said solution is created above said bulk of solid matter. Said thin layer of solution contains either said partially or fully dissolved portion P of said bulk of solid matter. It should be further noted that said thin layer of solution will eventually be extracted from said container and dispensed.

According to another embodiment of the present invention, said amount L of liquid is smaller than M.

According to another embodiment of the present invention, wherein said amount L of liquid is greater than M.

According to another embodiment of the present invention, the feeder additionally comprising at least one sensing means adapted to indicate at least one characteristic of said solution.

According to another embodiment of the present invention the sensing means are selected from a group consisting of mass flow meter, electrical conductive sensor, level indicator such as a float, a temperature sensor or any combination thereof.

According to another embodiment of the present invention the characteristic is selected from a group consisting of a temperature of said solution, the hydrostatic pressure, the mass or density of a portion of said solution evacuated off said container, the density, the electrical conductivity of said solution, and any combination thereof.

According to another embodiment of the present invention, the feeder additionally comprising at least one outlet pipe adapted for extracting at least a portion of said solution.

According to another embodiment of the present invention, the solid matter is in the form selected from a group consisting of powder, granular form or any combination thereof.

According to another embodiment of the present invention, the liquid is selected from a group consisting of water or any liquid selected from hydrophobic, hydrophilic solvents, lipophilic solvents, Lipophobic solvents, organic solvents, inorganic solvents or any combination thereof.

According to another embodiment of the present invention, the solid bulk M of solid matter is maintained wet or slurry.

According to another embodiment of the present invention, M is in the range of micro-grams to several hundreds of tons.

According to another embodiment of the present invention, P is in the range of micro-grams to several hundreds of tons.

According to another embodiment of the present invention, the feeder additionally comprising means adapted to introduce at least one solvent; said at least one solvent is adapted to flush excessive quantities of solute.

According to another embodiment of the present invention, the stream of flowing liquid is synchronized with portion of said solution extracted out of said container.

According to another embodiment of the present invention, the feeder additionally comprising sensing means adapted to indicate and maintain the amount of said solution in said container above a predefined threshold.

According to another embodiment of the present invention, the predefined threshold is at least a few millilitres.

According to another embodiment of the present invention, the container is in fluid connection with the ambient atmosphere.

According to another embodiment of the present invention, at least a portion of the wall of said outlet pipe is perforated.

According to another embodiment of the present invention, the feeder additionally comprising a filter adapted to prevent granules or solid matter from entering said outlet pipe.

According to another embodiment of the present invention, the feeder additionally comprising at least one skirting flange adapted to prevent leaking of said liquid out of said container.

According to another embodiment of the present invention, the container is made of material selected from a group consisting of plastic resin, polypropylene, a metal, stainless steel or any combination thereof.

According to another embodiment of the present invention, said material is adapted to prevent corrosion within said container.

According to another embodiment of the present invention, the feeder additionally comprising at least one controller adapted to verify the correct dosing of said stream of liquid introduced into said container.

According to another embodiment of the present invention, the feeder additionally comprising at least one level indicator, e.g., a float, adapted to maintain the amount of liquid within said container at a predefined level.

According to another embodiment of the present invention, the feeder comprises a combination of at least two containers, each of which comprises a substantially different solid matter or a mixture of different solid matters.

According to another embodiment of the present invention, the solid matter is selected from a group consisting of fertilizers, pesticides, chemicals, minerals, salts, or any combination thereof; further wherein said feeder is used in at least one selected from process industry, chemistry industry, pesticides industry, disinfestations, food industry (e.g., beverage industry), textile, cosmetics, detergents productions, pharmaceutical industry or any combination thereof.

According to another embodiment of the present invention, the feeder further comprising an intermediate collecting container, in fluid connection with the ambient atmosphere for intermediately storing said extracted portions of said solution.

According to another embodiment of the present, invention, the outlet pipe is structured as a siphon.

According to another embodiment of the present invention, the feeder is adapted to be used in a fertilizing and irrigating system.

It is within the scope of the present invention to provide a feeder for fertilizing and irrigating system having a receiving tank structured and arranged for receiving and storing a bulk of solid fertilizer, said feeder comprising:
at least one receiving tank; wherein said receiving tank receives, stores and contains a bulk of solid fertilizer of a given quantity
a feeding pipe connectable to a line leading fresh water for feeding said tank with discrete portions of said fresh water, such that a solution of said fertilizer is obtained within said receiving tank;
an outlet pipe for extracting discrete portions of said solution out of said receiving tank, and,
at least one measuring mean for sensing at least one characteristic associated with said portion of solution;
wherein said at least one characteristic is selected from the group consisting of the temperature of said solution; the level of hydrostatic pressure measured close to the aperture of said outlet pipe for a given height of the top level of solution resident in said receiving tank above the bottom of said receiving tank; the mass of a portion of solution evacuated off said receiving tank; the density of an evacuated portion of solution off said receiving tank; the electrical conductivity of the irrigating water after getting mixed with said evacuated portion of solution, and any combination thereof.

According to another embodiment of the present invention, the receiving tank is fluid connected to the ambient atmosphere.

According to another embodiment of the present invention, the feeder further comprising an intermediate collecting container, which is fluid connected to the ambient atmosphere for intermediately storing said evacuated portions of solution.

According to another embodiment of the present invention, the outlet pipe structured and arranged as a siphon.

According to another embodiment of the present invention, the feeder further comprising a measuring pipe, an air pump and a pressure sensor, and wherein one end of said measuring pipe closely disposed above the bottom of said receiving tank and the other end of said measuring pipe upwardly extends above the top of said receiving tank.

According to another embodiment of the present invention, the fresh water is introduced in either a continuous or a batch-like manner.

According to another embodiment of the present invention, the solid fertilizer is in the form selected from a group consisting of powder, granular form or any combination thereof.

According to another embodiment of the present invention, the solid fertilizer is maintained wet or slurry.

According to another embodiment of the present invention, the feeder additionally comprising means adapted to introduce at least one solvent; said at least one solvent is adapted to flush excessive quantities of solute.

According to another embodiment of the present invention, the introduction of said fresh water is synchronized with portion of said solution extracted out of said receiving tank.

According to another embodiment of the present invention, the feeder additionally comprising sensing means adapted to indicate and maintain the amount of said solution in said receiving tank above a predefined threshold.

According to another embodiment of the present invention, the predefined threshold is at least a few millilitres.

According to another embodiment of the present invention, at least a portion of the wall of said outlet pipe is perforated.

According to another embodiment of the present invention, the feeder additionally comprising a filter adapted to prevent granules or solid matter from entering said outlet pipe.

According to another embodiment of the present invention, the feeder additionally comprising at least one skirting flange adapted to prevent leaking of said liquid out of said receiving tank.

According to another embodiment of the present invention, the receiving tank is made of material selected from a group consisting of plastic resin, polypropylene, a metal, stainless steel or any combination thereof.

According to another embodiment of the present invention, the material is adapted to prevent corrosion within said receiving tank.

According to another embodiment of the present invention, the feeder additionally comprising at least one controller adapted to verify the correct dosing of said stream of liquid introduced into said receiving tank.

According to another embodiment of the present invention, the feeder additionally comprising at least one level indicator, e.g., a float, adapted to maintain the amount of liquid within said receiving tank at a predefined level.

According to another embodiment of the present invention, the feeder comprises a combination of at least two receiving tank, each of which comprises a substantially different solid matter or a mixture of different solid fertilizer.

It is another object of the present invention to provide a method for dispensing a solution of either at least partially or fully dissolved solid matter therein. The method comprises steps selected inter alia from:
a. obtaining:
   i) at least one container; wherein said container accommodates a bulk M of solid matter; and,
   ii) at least one feeding pipe;
b. fluidly connecting at least one of said feeding pipes with at least one of said containers
c. fluidly connecting at least one of said feeding pipes with at least one of said containers;
d. introducing an amount or volume L of flowing liquid into said container, thereby gradually dissolving a portion P of said bulk of solid matter within said liquids and providing said solution; where P is substantially smaller than M such that said container constantly contains a positive portion of said solid matter; said positive portion is defined by the subtraction between M and P.

It is another object of the present invention to provide the method as defined above, wherein said step of introducing a stream of flowing liquid is performed in either a continuous or a batch-like manner.

According to another embodiment of the present invention, said amount L of liquid is smaller than M.

According to another embodiment of the present invention, said amount L of liquid is greater than M

It is another object of the present invention to provide the method as defined above, additionally comprising step of repeatedly measuring the level of at least one characteristic associated with said solution resident in said container.

It is another object of the present invention to provide the method as defined above, additionally comprising step of deriving the level of concentration of said matter in said solution resident in said container.

It is another object of the present invention to provide the method as defined above, additionally comprising steps of (a) providing said feeder with at least one sensing means; and (b) indicating at least one characteristic of said solution.

It is another object of the present invention to provide the method as defined above, additionally comprising step of selecting said sensing means from a group consisting of mass flow meter, electrical conductive sensor, level indicator such as a float, a temperature sensor or any combination thereof.

It is another object of the present invention to provide the method as defined above, additionally comprising step of selecting said characteristic from a group consisting of a temperature of said solution, the hydrostatic pressure, the mass or density of a portion of said solution evacuated off said container, the density, the electrical conductivity of said solution, and any combination thereof.

It is another object of the present invention to provide the method as defined above, additionally comprising step of providing said feeder with at least one outlet pipe adapted for extracting at least a portion of said solution.

It is another object of the present invention to provide the method as defined above, additionally comprising step of providing said solid matter in the form selected from a group consisting of powder, granular form or any combination thereof.

It is another object of the present invention to provide the method as defined above, additionally comprising step of selecting said liquid from a group consisting of hydrophobic, hydrophilic solvents, lipophilic solvents, Lipophobic solvents, organic solvents, inorganic solvents or any combination thereof.

It is another object of the present invention to provide the feeder as defined above, wherein said liquid is water.

It is another object of the present invention to provide the method as defined above, wherein said solid bulk M of solid matter is maintained wet or slurry.

It is another object of the present invention to provide the method as defined above, wherein M is in the range of micro-grams to several hundreds of tons.

It is another object of the present invention to provide the method as defined above, wherein P is in the range of micro-grams to several hundreds of tons.

It is another object of the present invention to provide the method as defined above, additionally comprising step of introducing at least one solvent; said at least one solvent is adapted to flush excessive quantities of solute.

It is another object of the present invention to provide the method as defined above, additionally comprising step of synchronizing said stream of flowing liquid with portion of said solution extracted out of said container.

It is another object of the present invention to provide the method as defined above, additionally comprising step of indicating and maintaining the amount of said solution in said container above a predefined threshold.

It is another object of the present invention to provide the method as defined above, wherein said predefined threshold is at least a few millilitres.

It is another object of the present invention to provide the method as defined above, additionally comprising step of fluidly connecting said container with the ambient atmosphere.

It is another object of the present invention to provide the method as defined above, additionally comprising step of providing at least a portion of the wall of said outlet pipe perforated.

It is another object of the present invention to provide the method as defined above, additionally comprising step of preventing granules or solid matter from entering said outlet pipe by providing said feeder with a filter.

It is another object of the present invention to provide the method as defined above, additionally comprising step of providing said feeder with at least one skirting flange for preventing leaking of said liquid out of said container.

It is another object of the present invention to provide the method as defined above, additionally comprising step of providing said container from a material selected from a group consisting of plastic resin, polypropylene, a metal, stainless steel or any combination thereof.

It is another object of the present invention to provide the method as defined above, additionally comprising step of preventing corrosion within said container.

It is another object of the present invention to provide the method as defined above, additionally comprising step of providing said feeder with at least one controller adapted to verify the correct dosing of said stream of liquid introduced into said container.

It is another object of the present invention to provide the method as defined above, additionally comprising step of providing said feeder with at least one level indicator adapted to maintain the amount of liquid within said container at a predefined level.

It is another object of the present invention to provide the method as defined above, additionally comprising step of selecting said level indicator from a float.

It is another object of the present invention to provide the method as defined above, additionally comprising step of providing said feeder with a combination of at least two containers, each of which comprises a substantially different solid matter or a mixture of different solid matters.

It is another object of the present invention to provide the method as defined above, additionally comprising step of selecting said solid matter from a group consisting of fertilizers, pesticides, chemicals, minerals, salts, or any combination thereof; further wherein said feeder is used in at least one selected from process industry, chemistry industry, pesticides industry, disinfestations, food industry (e.g., beverage industry), textile, cosmetics, detergents productions, pharmaceutical industry or any combination thereof.

It is another object of the present invention to provide the method as defined above, additionally comprising step of providing said feeder with an intermediate collecting container, in fluid connection with the ambient atmosphere for intermediately storing said extracted portions of said solution.

It is another object of the present invention to provide the method as defined above, additionally comprising step of providing said outlet pipe is structured as a siphon.

It is another object of the present invention to provide the method as defined above, wherein said feeder is adapted to be used in a fertilizing and irrigating system.

It is another object of the present invention to provide the method as defined above, further comprising step of spaying discrete portions of said liquid on top of said solid matter for dissolving respective portions of said solid matter, and wherein said discrete portions of said liquid are significantly small.

It is another object of the present invention to provide the method as defined above, additionally comprising step of extracting said solution by means selected from a pump, gravitation or any combination thereof.

It is another object of the present invention to provide the method as defined above, additionally comprising step of measuring of hydrostatic pressure by measuring the level of pressure of air compressed into a measuring pipe one end of which dipped in said solution, and wherein said measuring effected at a stage in which the level of said solution contained in said pipe is given.

It is another object of the present invention to provide the method as defined above, additionally comprising step of introducing into said container an additionally amount of said solid matter.

It is another object of the present invention to provide the method as defined above, additionally comprising step of repeating said step of introducing into said container an additionally amount of said solid matter.

It is another object of the present invention to provide a method for dispensing aqueous solution of a solid fertilizer. The method comprises inter alia steps of:
a. providing at least one receiving tank; wherein said receiving tank contains bulk of solid fertilizer of a given quantity;
b. gradually dissolving said solid fertilizer in said receiving tank by repeatedly feeding said receiving tank with discrete portions of fresh water;
c. repeatedly measuring the level of at least one characteristic associated with said solution resident in said receiving tank and deriving the level of concentration of said fertilizer in said solution resident in said receiving tank by employing said measured level, and,
d. repeatedly evacuating portions of given quantities and concentration off said receiving tank;
wherein said feeder comprises an outlet pipe and a feeding pipe, and wherein said evacuating accomplished by means of said outlet pipe an aperture of which closely disposed above the bottom of said receiving tank, and wherein said feeding accomplished by means of said feeding pipe which is structured and arranged to lead fresh water into said receiving tank, such that the level of said aqueous solution resident in said receiving tank does not get below a predefined threshold level, and wherein said at least one characteristic selected from a group of characteristics consisting of a temperature of said solution, the level of hydrostatic pressure measured close to the aperture of said outlet pipe for a given height of the top level of solution resident in the receiving tank above to bottom of said receiving tank, the mass of a portion of solution evacuated off said receiving tank, the density of a portion of solution evacuated off said receiving tank, the electrical conductivity of the irrigating water after getting mixed with said evacuated portion of solution, and any combination thereof.

It is another object of the present invention to provide the method as defined above, further comprising spaying said discrete portions of fresh water on top of said solid fertilizer for dissolving respective portions of said solid fertilizer, and wherein said discrete portions of fresh water are significantly small compared to said given quantity.

It is another object of the present invention to provide the method as defined above, further comprising intermediately storing said evacuated portions of solution in an intermediate collecting container.

It is another object of the present invention to provide the method as defined above, wherein said evacuating accomplished by means of a pump, or gravitation or any combination thereof.

It is still another object of the present invention to provide the method as defined above, wherein said measuring of said hydrostatic pressure accomplished by measuring the level of pressure of air compressed into a measuring pipe one end of which dipped in said aqueous solution, and wherein said measuring effected at a stage in which the level of said aqueous solution contained in said pipe is given.

It is still an object of the present invention to provide the method as defined above, wherein said level of aqueous solution contained in said pipe equals said predefined threshold.

According to another embodiment of the present invention, the solid matter within the container (or alternatively within the receiving tank) chemically reacts with the liquid and as a result of said chemical reaction—dissolves.

According to another embodiment of the present invention, the container (or alternatively the receiving tank) is perforated. According to another embodiments said perforated container (or alternatively the perforated receiving tank) functions as a filter such that the liquid is introduced (in either a continuous or batch-like manner) into said perforated container (or alternatively said perforated receiving tank) and either (i) chemical reacts, or (ii) dissolve the solid matter within the same. Once the solid matter is dissolved, the same is collected from the container's (or the receiving tank's) bottom.

In the foregoing description, embodiments of the invention, including preferred embodiments, have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

1-97. (canceled)

98. A feeder for dispensing a solution, comprising
a. at least one container; wherein said container enclosing a bulk M of solid matter;
b. at least one feeding pipe, in fluid connection with said container, adapted to introduce an amount or volume L of a stream of flowing liquid into said container; wherein a portion P of said bulk of solid matter is either at least partially dissolved or fully dissolved within said liquid such that said solution is provided; wherein P is substantially smaller than M, such that said container constantly contains a positive portion of said solid matter; said positive portion is defined by the subtraction between M and P.

99. The feeder according to claim 98, additionally comprising means for constantly measuring at least one characteristic associated with said solution resident in said container and deriving the concentration of said solid matter in said solution.

100. The feeder according to claim 98, wherein at least one of the following is being held true (a) said stream of flowing liquid is introduced in either a continuous or a batch-like manner; (b) said amount or volume L of liquid is either smaller or greater than M; (c) said feeder additionally comprising at least one sensing means adapted to indicate at least one characteristic of said solution; (d) said sensing means are selected from a group consisting of mass flow meter, electrical conductive sensor, level indicator such as a float, a temperature sensor or any combination thereof; (e) said characteristic is selected from a group consisting of a temperature of said solution, the hydrostatic pressure, the mass or density of a portion of said solution evacuated off said container, the density, the electrical conductivity of said solution, and any combination thereof; and any combination thereof.

101. The feeder according to claim 98, wherein at least one of the following is being held true (a) said feeder additionally comprising at least one outlet pipe adapted for extracting at least a portion of said solution; (b) said solid matter is in the form selected from a group consisting of powder, granular form or any combination thereof; (c) said liquid is selected from a group consisting of water or any liquid solvent selected from hydrophobic, hydrophilic solvents, lipophilic solvents, Lipophobic solvents, organic solvents, inorganic solvents or any combination thereof; (d) said solid bulk M of solid matter is maintained wet or slurry; (e) M is in the range of micro-grams to several hundreds of tons; (f) P is in the range of micro-grams to several hundreds of tons; and any combination thereof.

102. The feeder according to claim 98, additionally comprising at least one selected from a group consisting of (a) means adapted to introduce at least one solvent; said at least one solvent is adapted to flush excessive quantities of solute; (b) sensing means adapted to indicate and maintain the amount of said solution in said container above a predefined threshold; (c) at least one skirting flange adapted to prevent leaking of said liquid out of said container; (d) at least one controller adapted to verify the correct dosing of said stream of liquid introduced into said container; (e) at least one level indicator adapted to maintain the amount of liquid within said container at a predefined level; (f) at least one level indicator being a float adapted to maintain the amount of liquid within said container at a predefined level or any combination thereof.

103. The feeder according to claim 102, wherein said stream of flowing liquid is synchronized with portion of said solution extracted out of said container.

104. The feeder according to claim 102, wherein said predefined threshold is at least a few millilitres.

105. The feeder according to claim 98, wherein container is in fluid connection with the ambient atmosphere.

106. The feeder according to claim 102, wherein at least a portion of the wall of said outlet pipe is perforated.

107. The feeder according to claim 102, additionally comprising a filter adapted to prevent granules or solid matter from entering said outlet pipe.

108. The feeder according to claim 98, wherein said container is made of material selected from a group consisting of plastic resin, polypropylene, a metal, stainless steel or any combination thereof; further wherein said material is adapted to prevent corrosion within said container.

109. The feeder according to claim 98, wherein at least one of the following is being held true (a) said feeder comprising a combination of at least two containers, each of which comprises a substantially different solid matter or a mixture of different solid matters; (b) said feeder is adapted to be used in a fertilizing and irrigating system; (c) said solid matter is selected from a group consisting of fertilizers, pesticides, chemicals, minerals, salts, or any combination thereof; further wherein said feeder is used in at least one selected from process industry, chemistry industry, pesticides industry, disinfestations, food industry (e.g., beverage industry), textile, detergents productions, pharmaceutical industry, cosmetics or any combination thereof; (d) said feeder further comprising an intermediate collecting container, in fluid connection with the ambient atmosphere for intermediately storing said extracted portions of said solution; and any combination thereof.

110. The feeder according to claim 101, wherein said outlet pipe is structured as a siphon.

111. A feeder for fertilizing and irrigating system having a receiving tank structured and arranged for receiving and storing a bulk of solid fertilizer, said feeder comprising:
at least one receiving tank; wherein said receiving tank receives, stores and contains a bulk of solid fertilizer of a given quantity;
a feeding pipe connectable to a line leading fresh water for feeding said tank with discrete portions of said fresh water, such that a solution of said fertilizer is obtained within said receiving tank;
an outlet pipe for extracting discrete portions of said solution out of said receiving tank, and,
at least one measuring mean for sensing at least one characteristic associated with said portion of solution;
wherein said at least one characteristic is selected from the group consisting of the temperature of said solution; the level of hydrostatic pressure measured close to the aperture of said outlet pipe for a given height of the top level of solution resident in said receiving tank above the bottom of said receiving tank; the mass of a portion of solution evacuated off said receiving tank; the density of an evacuated portion of solution off said receiving tank; the electrical conductivity of the irrigating water after getting mixed with said evacuated portion of solution, and any combination thereof.

112. The feeder for fertilizing and irrigating system as in claim 111, wherein at least one of the following is being held true: (a) said receiving tank is fluid connected to the ambient atmosphere; (b) said outlet pipe structured and arranged as a siphon; (c) said fresh water is introduced in either a continuous or a batch-like manner; (d) solid fertilizer is in the form selected from a group consisting of powder, granular form or any combination thereof; (e) said solid fertilizer is maintained wet or slurry; (f) said introduction of said fresh water is synchronized with portion of said solution extracted out of said receiving tank; and any combination thereof.

113. The feeder for fertilizing and irrigating system as in claim 111, further comprising at least one being selected from a group consisting of (a) an intermediate collecting container, which is fluid connected to the ambient atmosphere for intermediately storing said evacuated portions of solution; (b) a measuring pipe, an air pump and a pressure sensor, and wherein one end of said measuring pipe closely disposed above the bottom of said receiving tank and the other end of said measuring pipe upwardly extends above the top of said receiving tank; (c) means adapted to introduce at least one solvent; said at least one solvent is adapted to flush excessive quantities of solute; (d) sensing means adapted to indicate and maintain the amount of said solution in said receiving tank above a predefined threshold; and any combination thereof.

114. The feeder for fertilizing and irrigation system as in claim 113, wherein said predefined threshold is at least a few millilitres.

115. The feeder for fertilizing and irrigation system as in claim 111, wherein at least one of the following is being held true (a) a portion of the wall of said outlet pipe is perforated; (b) said feeder comprising a combination of at least two receiving tank, each of which comprises a substantially different solid matter or a mixture of different solid fertilizer; and any combination thereof.

116. The feeder for fertilizing and irrigation system as in claim 113, additionally comprising at least one selected from a group consisting of (a) filter adapted to prevent granules or solid matter from entering said outlet pipe; (b) at least one skirting flange adapted to prevent leaking of said liquid out of said receiving tank; and any combination thereof.

117. The feeder for fertilizing and irrigation system as in claim 113, wherein said receiving tank is made of material selected from a group consisting of plastic resin, polypropylene, a metal, stainless steel or any combination thereof; further wherein said material is adapted to prevent corrosion within said receiving tank.

118. The feeder for fertilizing and irrigation system as in claim 111, additionally comprising at least one being selected from a group consisting of (a) at least one controller adapted to verify the correct dosing of said stream of liquid introduced into said receiving tank; (b) at least one level indicator adapted to maintain the amount of liquid within said receiving tank at a predefined level; (c) at least one level indicator being a float adapted to maintain the amount of liquid within said receiving tank at a predefined level; and any combination thereof.

119. A method for dispensing a solution of either partially or fully dissolved solid matter therein, comprising steps of:
a. obtaining:
i) at least one container; wherein said container accommodates a bulk M of solid matter; and,
ii) at least one feeding pipe;
b. accommodating within said container said bulk M of solid matter;
c. fluidly connecting at least one of said feeding pipes with at least one of said containers;
d. introducing an amount or volume L of a stream of flowing liquid into said container, thereby gradually dissolving a portion P of said bulk of solid matter within said liquids and providing said solution; where P is substantially smaller than M.

120. The method according to claim 119, wherein at least one of the following is being held true (a) said feeder is adapted to be used in a fertilizing and irrigating system; (b) said step of introducing a stream of flowing liquid is performed in either a continuous or a batch-like manner; (c) said amount or volume L of liquid is either smaller than M or greater than M; and any combination thereof.

121. The method according to claim 119, additionally comprising at least one step being selected from a group consisting of (a) repeatedly measuring the level of at least one characteristic associated with said solution resident in said container; (b) deriving the level of concentration of said matter in said solution resident in said container; (c) selecting said sensing means from a group consisting of mass flow meter, electrical conductive sensor, level indicator such as a float, a temperature sensor or any combination thereof; (d) selecting said characteristic from a group consisting of a temperature of said solution, the hydrostatic pressure, the mass or density of a portion of said solution evacuated off said container, the density, the electrical conductivity of said solution, and any combination thereof; (e) providing said feeder with at least one outlet pipe adapted for extracting at least a portion of said solution; and any combination thereof.

122. The method according to claim 119, additionally comprising steps of (a) providing said feeder with at least one sensing means; and (b) indicating at least one characteristic of said solution.

123. The method according to claim 119, additionally comprising at least one step being selected from a group consisting of (a) providing said solid matter in the form selected from a group consisting of powder, granular form or any combination thereof; (b) selecting said liquid from a group consisting of hydrophobic, hydrophilic solvents, lipophilic solvents, Lipophobic solvents, organic solvents, inorganic solvents or any combination thereof; and any combination thereof.

124. The method according to claim 119, wherein at least one of the following is being held true (a) said solid bulk M of solid matter is maintained wet or slurry; (b) M is in the range of micro-grams to several hundreds of tons; P is in the range of micro-grams to several hundreds of tons; (c) introducing at least one solvent; said at least one solvent is adapted to flush excessive quantities of solute; (d) synchronizing said stream of flowing liquid with portion of said solution extracted out of said container; (e) indicating and maintaining the amount of said solution in said container above a predefined threshold; and any combination thereof.

125. The method according to claim 124, wherein said predefined threshold is at least a few millilitres.

126. The method according to claim 119, additionally comprising at least one step selected from a group consisting of (a) fluidly connecting said container with the ambient atmosphere; (b) providing at least a portion of the wall of said outlet pipe perforated; (c) preventing granules or solid matter from entering said outlet pipe by providing said feeder with a filter; (d) providing said feeder with at least one skirting flange for preventing leaking of said liquid out of said container; (e) providing said container from a material selected from a group consisting of plastic resin, polypropylene, a metal, stainless steel or any combination thereof; (f) preventing corrosion within said container; and any combination thereof.

127. The method according to claim 119, additionally comprising at least one step selected from a group consisting of (a) providing said feeder with at least one controller adapted to verify the correct dosing of said stream of liquid introduced into said container; (b) providing said feeder with at least one level indicator adapted to maintain the amount of liquid within said container at a predefined level; (c) providing said feeder with a combination of at least two containers, each of which comprises a substantially different solid matter or a mixture of different solid matters; (d) selecting said solid matter from a group consisting of fertilizers, pesticides, chemicals, minerals, salts, or any combination thereof; further wherein said feeder is used in at least one selected from process industry, chemistry industry, pesticides industry, disinfestations, food industry, textile, cosmetics, detergents productions, pharmaceutical industry or any combination thereof or any combination thereof; (e) providing said feeder with an intermediate collecting container, in fluid connection with the ambient atmosphere for intermediately storing said extracted portions of said solution; (f) providing said outlet pipe is structured as a siphon; and any combination thereof.

128. The method according to claim 119, further comprising at least one step selected from a group consisting of (a) spaying discrete portions of said liquid on top of said solid matter for dissolving respective portions of said solid matter, and wherein said discrete portions of said liquid are significantly small; (b) extracting said solution by means selected from a pump, gravitation or any combination thereof; (c) measuring of hydrostatic pressure by measuring the level of pressure of air compressed into a measuring pipe one end of which dipped in said solution, and wherein said measuring effected at a stage in which the level of said solution contained in said pipe is given; (d) introducing into said container an additionally amount of said solid matter; (e) repeating said step of introducing into said container an additionally amount of said solid matter; and any combination thereof.

129. A method for dispensing aqueous solution of a solid fertilizer, said method comprising steps of:
a. providing at least one receiving tank; wherein said receiving tank contains bulk of solid fertilizer of a given quantity;
b. gradually dissolving said solid fertilizer in said receiving tank by repeatedly feeding said receiving tank with discrete portions of fresh water;
c. repeatedly measuring the level of at least one characteristic associated with said solution resident in said receiving tank and deriving the level of concentration of said fertilizer in said solution resident in said receiving tank by employing said measured level, and
d. repeatedly evacuating portions of given quantities and concentration off said receiving tank, and
wherein said feeder comprises an outlet pipe and a feeding pipe, and wherein said evacuating accomplished by means of said outlet pipe an aperture of which closely disposed above the bottom of said receiving tank, and wherein said feeding accomplished by means of said feeding pipe which is structured and arranged to lead fresh water into said receiving tank, such that the level of said aqueous solution resident in said receiving tank does not get below a predefined threshold level, and wherein said at least one characteristic selected from a group of characteristics consisting of a temperature of said solution, the level of hydrostatic pressure measured close to the aperture of said outlet pipe for a given height of the top level of solution resident in the receiving tank above to bottom of said receiving tank, the mass of a portion of solution evacuated off said receiving tank, the density of a portion of solution evacuated off said receiving tank, the electrical conductivity of the irrigating water after getting mixed with said evacuated portion of solution, and any combination thereof.

130. The method as in claim 129, further comprising at least one step selected from a group consisting of (a) spaying said discrete portions of fresh water on top of said solid fertilizer for dissolving respective portions of said solid fertilizer, and wherein said discrete portions of fresh water are significantly small compared to said given quantity; (b) intermediately storing said evacuated portions of solution in an intermediate collecting container; (c) accomplishing said measuring of said hydrostatic pressure by measuring the level of pressure of air compressed into a measuring pipe one end of which dipped in said aqueous solution, and wherein said measuring effected at a stage in which the level of said aqueous solution contained in said pipe is give; and any combination thereof.

131. The method as in claim 129, wherein at least one of the following is being held true (a) said evacuating accomplished by means of a pump, or gravitation or any combination thereof; (b) said level of aqueous solution contained in said pipe equals said predefined threshold; and any combination thereof.
